(19) United States
(12) Patent Application Publication
(10) Pub. No.: US 2011/0227818 A1
(43) Pub. Date: Sep. 22, 2011

(54) MONITOR AND DISPLAY METHOD THEREOF

(75) Inventor: CHEN-KANG SU, TAIPEI (TW)

(73) Assignee: ACER INCORPORATED, Taipei County (TW)

(21) Appl. No.: 12/779,062

(22) Filed: May 13, 2010

(30) Foreign Application Priority Data
Mar. 19, 2010 (TW) 099108221

(51) Int. Cl. G09G 3/36

(52) U.S. Cl. 345/102

(57) ABSTRACT

The invention discloses a monitor and a display method thereof. The monitor comprises a display panel, a backlight module and a control module, and the backlight module comprises a plurality of light emitting diodes lighting with a first period. The display method in accordance with the present invention comprises the flowing steps of: receiving a plurality of frame signals, and comparing a difference of any two adjacent frame signals with a threshold value by the control module; controlling the backlight module emitting with a second period.

### FIELD

The exemplary embodiments of the present invention relates to a field of a monitor and a display method thereof. More specifically, the exemplary embodiments of the present invention relates to a monitor and a display method thereof using color sequential method.

### BACKGROUND

Nowadays, the display method of light emitting diodes (LED) is emitting white light by backlight and presenting pixel images with grey-scale through liquid crystal controlled by thin-film transistor (TFT) array. The pixel images are obtained by filtering color image through the color filter array.

Color sequential method (or field sequential color-FSC) utilizes ROB color (red, green, and blue) to mix the colors instead of filtering white light through the filters and changing the colors like the conventional backlight-method. If at least two colors are reflected onto human eyes, another color will be felt because the colors are mixing on the retina, that is, additive mixture of color stimuli. Also, the additive mixture of color stimuli using three independent color lights can obtain arbitrary color lights, so called the RGB rule. Therefore, the color sequential method can achieve the effect of color additive mixture by utilizing the limitation of human eyesight.

The feature of the backlight method in color sequential method is adjusting the luminance of each color independently by using a variety of color sources to obtain uniform luminance on the screen. Comparing to the color LCD using color filter and additive mixture, using the red, green, and blue light source independently has obvious advantages as following:
(1) high definition;
(2) fewer driver ICs;
(3) color uniform adjustment can be performed; and
(4) color filter is unnecessary, thus the structure of the LCD chamber can be simplified and the space can be reduced.

The conventional LCD display driving by color sequential method can be divided into three steps according to the timeframe. The first step is opening and charging the TFT used for scanning each pixel. The second step is transferring the liquid crystal to the optional rotation location according to the voltage and the electrical field applied by the TFT for obtaining the correct grey-scale luminance. Then the third step is quickly flashing the red backlight after the optional rotation, this time only one-third of the frame image is finished. By the aforementioned method, the green light and blue light backlight driving methods are finished respectively so as to achieve a color image of the whole frame time (16.67 ms). Thus if the color sequential method is used in the liquid crystal, the liquid crystal must achieve the fast response function and the charging time of the TFT unit must be fast.

However, in the conventional LCD display driven by the color sequential method, color breakup and image contouring sometimes happen. The color breakup happens because the color generated by the color wheel is formed on eyes in sequence and the human eyes and the images are fast moving. The conventional digital light processing projector adopted the color sequential method divides the color of color wheel into multiple areas and gathers RGB colors in shorten time for solving the color breakup problem. However, dividing the color area of the color wheel will reduce the effective area of the color wheel (14 degrees between each color area) and affect the bit numbers of the grey-scale images. These drawbacks cause a dilemma or image contouring and color breakup problem.

### SUMMARY

In spite of the drawbacks of the aforementioned prior art, an object of the present invention is providing a monitor and a display method thereof to solve the problem of image contouring and color breakup problem.

According to an object of the present invention, a monitor is rendered and comprises a display panel, a backlight module and a control module, and the backlight module comprises a plurality of light emitting diodes emitting light with the first period. The control module receives a plurality of frame signals, and compares a difference of any two adjacent frame signals with a threshold. Also the control module controls the backlight module to emit with a second period when the difference is larger than the threshold.

Also, the backlight module is controlled to emit with the third period when the difference is smaller than the threshold.

Besides, the control module adjusts the emitting sequence or the emitting time of the plurality of light emitting diodes according to the color characteristic of each frame signals.

Further, the control module divides the display panel into a plurality of areas, and each of the frames, displayed by each area, corresponds to a portion of each of the frame signals; the control module calculates an area characteristic value of each area by utilizing the portion of each area, collects the area characteristic value of each area, and determines the color characteristic value of each frame signals accordingly.

According to another object of the present invention, a monitor is provided and comprises a display panel, a backlight module and a control module, and the backlight module comprises a plurality of light emitting diodes emitting light with the first period. The control module electrically connects to the display panel and the backlight module, and also adjusts the emitting sequence or the emitting time of the plurality of light emitting diodes according to a color characteristic of each frame signal.

Furthermore, the control module divides the display panel into a plurality of areas, and each of the frames, displayed by each area, corresponds to a portion of each frame signal. The control module calculates an area characteristic value of each area by utilizing the portion of each area, collects the area characteristic value of each area, and determines the color characteristic value of each frame signals accordingly.

Moreover, the control module utilizes a portion of each frame signal, corresponding to the frame of each area, to calculate the saturation and the hue of each area respectively, and the color characteristic value of each area is determined according to the saturation and the hue.

Besides, the control module receives a plurality of frame signals and comprises a difference of any two of the adjacent frame signals and a threshold and the backlight module is controlled to emit with the second period when the difference is larger than the threshold.

According to another object of the present invention, a display method of a monitor is rendered. The monitor comprises a display panel, a backlight module and a control module, and the backlight module comprises a plurality of light emitting diodes emitting light with a first period. The display method comprises the following steps: receiving a plurality of frame signals by the control module; comparing a difference of any two of the adjacent frame signals with a threshold by the control module; and controlling the backlight module to emit light with the second period when the difference is larger than the threshold.

Also, the backlight module is controlled to emit light with the third period when the difference is smaller than the threshold.

Besides, the control module adjusts the emitting sequence or the emitting time of the plurality of light emitting diodes according to a color characteristic of each frame signal.

Further, the control module divides the display panel into a plurality of areas, and each of the frames, displayed by each area, corresponds to a portion of each frame signal; the control module calculates an area characteristic value of each area by utilizing the portion of each area, collects the area characteristic value of each area, and determines the color characteristic value of each frame signals accordingly.

Also, the control module utilizes the portion of each frame signal, corresponding to the frame of each area, to calculate the saturation and the hue of each of the areas respectively, and the color characteristic value of each of the areas is determined accordingly.

According to another object of the present invention, a display method of a monitor is provided. The monitor comprises a display panel, a backlight module and a control module, and the backlight module comprises a plurality of light emitting diodes emitting light with the first period. The display method comprises the following steps: receiving frame signals by the control module; emitting light with a first period by the backlight module to display frames on the display panel; and adjusting the emitting sequence or the emitting time of the plurality of light emitting diodes according to a color characteristic of each frame signal by the control module.

Furthermore, the control module may divide the display panel into a plurality of areas, and each of the frames, displayed by each area, corresponds to a portion of each of the frame signals. The control module may calculate an area characteristic value of each area by utilizing the portion of each area, collect the area characteristic value of each area, and determine the color characteristic value of each frame signal accordingly.

Moreover, the control module utilizes a portion of each frame signal, corresponding to the frame of each area, to calculate the saturation and the hue of each area respectively, and the color characteristic value of each area is determined accordingly.

Besides, the control module receives a plurality of frame signals and comprises a difference of any two of the adjacent frame signals and a threshold. Also, the backlight module may be controlled to emit light with the second period when the difference is larger than the threshold.

The aforementioned monitor and display method have at least one of the following advantages:

(1) The monitor and the display method can compare the difference of any two of the adjacent frame signals with a threshold, and determine the emitting mode of each backlight module. The dilemma of image contouring and color breakup problem thus can be solved.

(2) The monitor and the display method can adjust the emitting sequence or the emitting time of the light emitting diodes so as to solve the color breakup problem.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a block diagram in accordance with one embodiment of the present invention;

FIG. 2A illustrates a schematic view of a LED emitting light with the first period in accordance with the present invention;

FIG. 2B illustrates a schematic view of a LED emitting light with the third period in accordance with the present invention;

FIG. 2C illustrates a schematic view of a LED emitting light with the second period in accordance with the present invention;

FIG. 3 illustrates a schematic view of diving the display panel into multiple areas by the control module in accordance with the present invention;

FIG. 4 illustrates a schematic view of the color UV plane in accordance with the present invention;

FIG. 5 illustrates a schematic view of the color sequence generated by adjusting the LED emitting time and the emitting sequence in accordance with the present invention;

FIG. 6 is a flow chart illustrating the display method in accordance with the present invention; and

FIG. 7 is a flow chart illustrating a color characteristic determining method in accordance with the present invention.

### DETAILED DESCRIPTION

Exemplary embodiments of the present invention are described herein in the context of a monitor and a display method thereof.

Those of ordinary skilled in the art will realize that the following detailed description of the exemplary embodiments is illustrative only and is not intended to be in any way limiting. Other embodiments will readily suggest themselves to such skilled persons having the benefit of this disclosure. Reference will now be made in detail to implementations of the exemplary embodiments as illustrated in the accompanying drawings. The same reference indicators will be used throughout the drawings and the following detailed description to refer to the same or like parts.

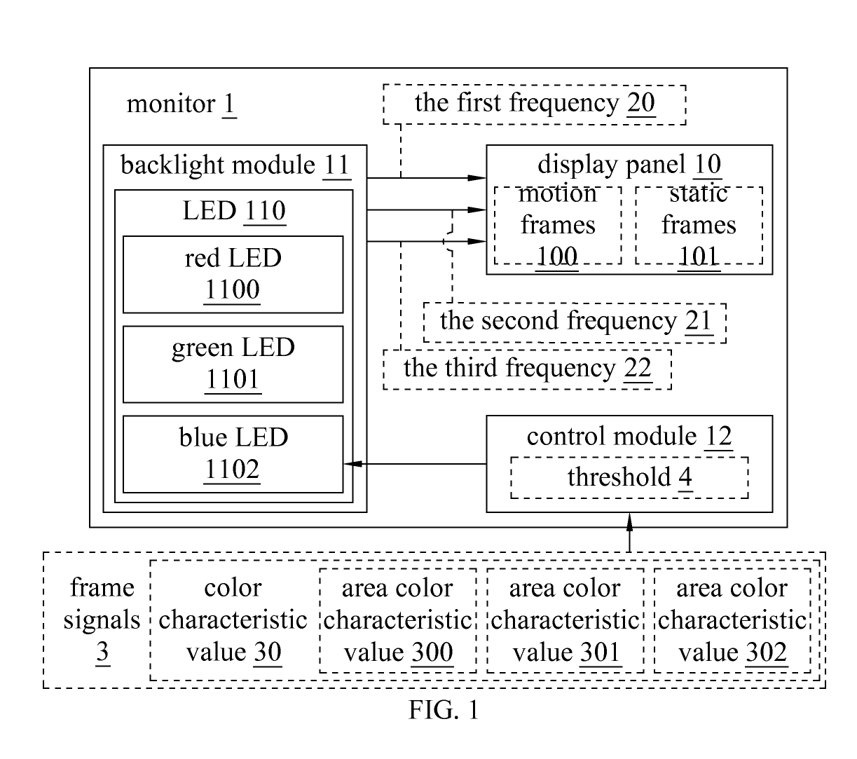

Please refer to FIG. 1, which illustrates a block diagram in accordance with one embodiment of the present invention. As shown, the monitor 1 comprises a display panel 10, a backlight module 11 and a control module 12. The display panel 10 is used for displaying frames and the backlight module 11 comprises a plurality of light emitting diodes 110. The light emitting diodes 110 comprise a red light emitting diode 1100, a green light emitting diode 1101, and a blue light emitting diode 1102. Also, the light emitting diodes 110 are emitting light with the first period 20 to display frames on the display panel 10. The control module 12 electrically connects to the display panel 10 and the backlight module 11, receives a plurality of frame signals 3, and compares a difference of any two adjacent frame signals with a threshold 4. The control module 12 also controls the backlight module 11 to emit light with the second period 21 when the difference is larger than the threshold 4 so that the display panel 10 can display motion frames 100. Besides, the control module 12 adjusts the emitting sequence or the emitting time of the plurality of light emitting diodes 110 according to a color characteristic 30 of each frame signal. Therefore, the control module 12 controls the backlight module 11 to emit light with the third period 22 when the difference is smaller than the threshold 4, and thus the display panel 10 will display a static frame 101.

Furthermore, the control module 12 divides the display panel 10 into a plurality of areas, and each of the frames, displayed on each area, corresponds to a portion of each of the frame signals 3. Then the area characteristic values (300, 301, and 302) of each area are collected and the color characteristic value 30 of each frame signals thus can be determined accordingly. Also, the control module 12 utilizes a portion of each of the frame signals 3, corresponding to the frame of each area, to calculate the saturation and the hue of each area respectively, and the area characteristic values (300, 301, and 302) of each area is determined accordingly.

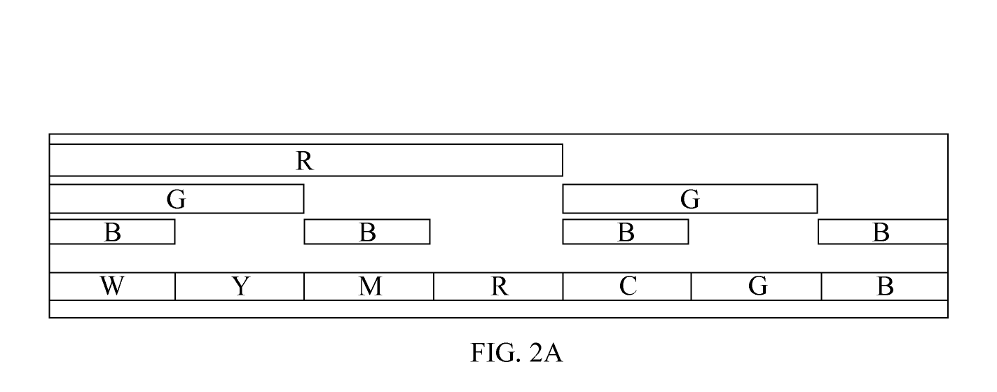

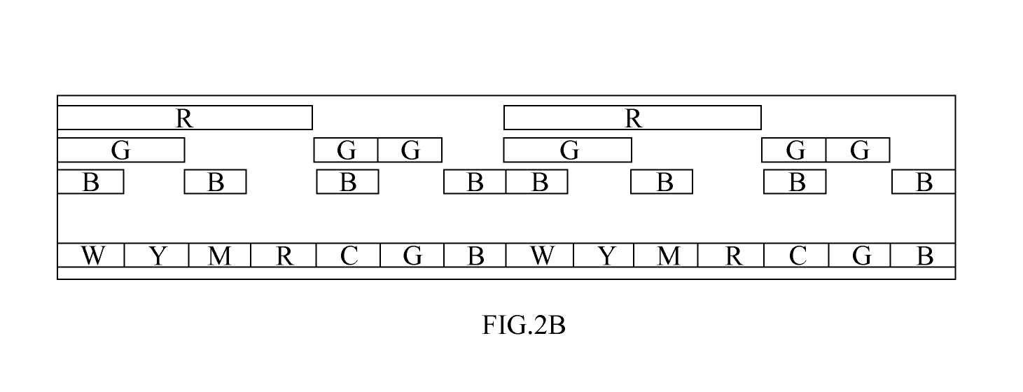

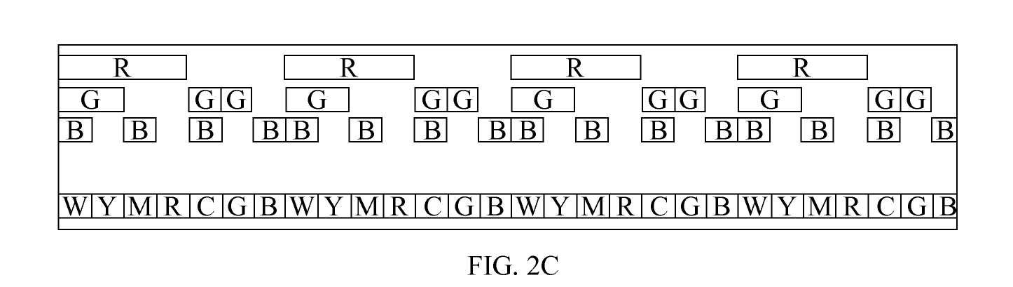

Please refer to FIG. 2A, which illustrates a schematic view of a LED emitting light with the first period in accordance with the present invention. As shown, the y-axis represents category different kinds of LEDs, and the x-axis is the emitting duration of each LED. Thus the bottom of the y-axis is the color row consisting of different LEDs. In the present embodiment, the color sequence from the left to the right are consisting of white, yellow, magenta, red, cyan, green, and blue (W, Y, M, R, C, t B). Also, the period from the appearance of white LED to the ending of the blue LED is the first period 20, and the first period 20 is 1/60 second in the present invention.

After receiving the frame signals 3, the control module 12 processes the received frame signals 3 to go through the motion detection. The motion detection is comparing a difference of any two of the adjacent frame signals 3 with a threshold 4. That is, determining the relationship between the moving vector of each of the frame signals 3 and the threshold 4. When the difference is smaller than the threshold 4, the images are static images. The image break up problem is not usually found in the static images, but the contouring problem easily happens. Thus, the color bits should be added to improve the contouring problem. Therefore the control module 12, in the display time ( 1/60 sec), controls the LED 110 of the backlight module 11 emitting light by the third period 22 so as to display a static frame 101 by a display panel 10, as shown in FIG. 2B. In the present embodiment, the third period, from the appearance of white LED to the ending of the blue LED, is 1/120 second. As a result, the display period of the LED 110 can improve color bits and the repeat period of 1/120 second can avoid the flashing feeling to human eyes.

When the difference is larger than the threshold 4, the images are indicated as motion pictures. Because of using the sequences display, the colors are formed on the eyes in time sequence and the fast moving of the eyes or images will cause color break up, so the color break up usually happens in the motion pictures. At this time, the control module 12 controls the backlight module 11 to emit light by the second period 21 so as to display a motion frame 100 on the display panel 10, and the second period may be three cycles ( 1/180 second) or four cycles ( 1/240 second). The present embodiment adopts the four cycles ( 1/240 second). As shown in FIG. 2C, the control module 12, in the display time ( 1/60 second) of a frame, controls the backlight module 11 to emit light by the second period 21 to display a motion frame 100 on the display panel 10. The second frequency may be the three cycles ( 1/180 second) or the four cycles ( 1/240 second), and the present embodiment adopts the four cycles ( 1/240 second). As shown in FIG. 2C, the control module 12 controls the LED 110 of the backlight module 11 to emit light and to form colors at four cycles in the display time ( 1/60 second) of a frame. Comparing to the image formed at one time, the present invention shortens the duration of color forming and avoids the happiness of color break up.

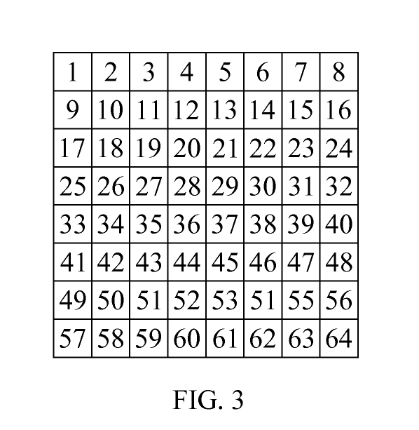

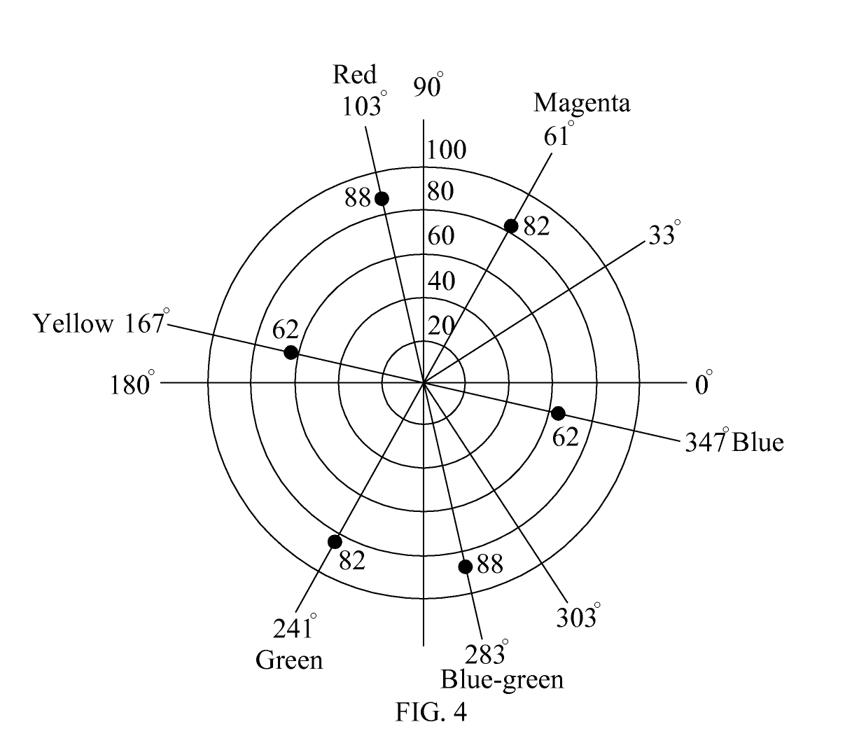

Besides, the control module 12 divides the display panel 10 into a plurality of areas. As shown in FIG. 3, the present embodiment divides the display panel 10 into 64 areas (8*8), and the frame of each area corresponds to a portion of each frame signals 3. At this time, the control module 12 utilizes the portion, corresponding to each portion, of each of the frame signals 3, and converts the portion into the YUV color space of the colors. As shown in FIG. 4, a schematic view of the color UV plane in accordance with the present invention is illustrated. As shown, the angles of the R, G, B, Y, C, and M on the color plane represent the hue values, and the W information can be obtained by the calculation of the saturation (the smaller of the saturation, the closer to the white). The average YUV value of each area is YₐUₐVₐ, and the saturation and the hue of each area are converted into Sa and Ha to represent the area characteristic value of each area. In addition, the conversion of the saturation and the hue values is according to the following formulas:

Sₐ=(Uₐ²+Vₐ²)^{1/2};

and

Hₐ=tan⁻¹(Vₐ/Uₐ)∘

By the aforementioned conversion, the hue value Ha and saturation value Sa of each area can be obtained and then the control module 12 integrates all the area characteristic values to calculate the color characteristic value 30 of each single frame signal of frame signals 3. Following the control module 12 chooses the proper RGB overlap ratio from the overlap table according to the color characteristic value 30, that is, the emitting sequence, the emitting time, or both. The RGBYCMW characteristics of each area are determined by the following table:

| Color | W | R | Y | G | C | B | M |
|---|---|---|---|---|---|---|---|
| Saturation | 0~0.2 | 0.2~1 | 0.2~1 | 0.2~1 | 0.2~1 | 0.2~1 | 0.2~1 |
| Hue | NA | 82~135 | 136~204 | 205~262 | 263~315 | 316~24 | 25~82 |

When the saturation value Sa is between 0 to 0.2, the control module 12 concludes the area characteristic of this area is white, and on the other hand, when the hue value Ha is on the corresponding hue, the control module 12 concludes that the area characteristic value is one of the RGBYCM. Then the control module 12 collects the data from all 64 areas, and the color characteristic value 30 of the frame signals 3 is the color with largest number, for example, the color of yellow is prevalent in the area numbers, such as 32 areas, the color characteristic value 30 of the frame signals 3 is 50% Y (32/64=50%).

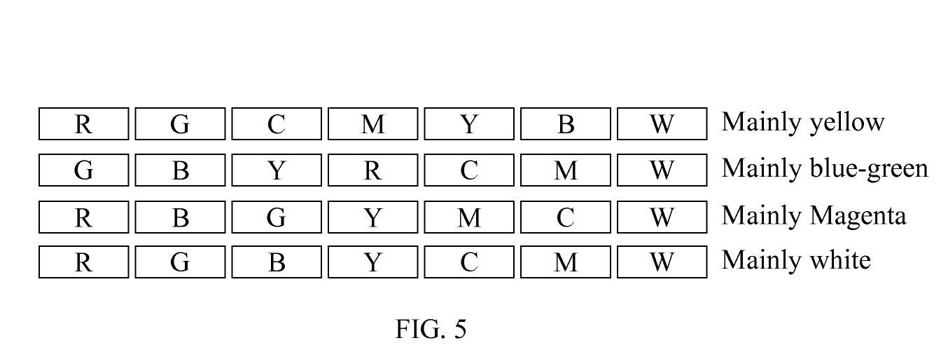

Please refer to FIG. 5, which illustrates a schematic view of the color sequence generated by adjusting the LED emitting time and the emitting sequence in accordance with the present invention. As shown, after the characteristic value 30 of the frame signals 3 is determined, the control module 12 rearranges the RGBYCMW sequence displayed by the LED 110. In an embodiment, the main color of the frame signals 3 is allocated uniformly to the display sequence of the LED 110. For example, when the color yellow occupies the most of the portions of the image, the emitting time, the emitting sequence, or both can be adjusted to display the generated color sequence RGCMYBW. Because the RG (for mixing yellow) and Y are separated evenly and the color forming ability is evenly allocated on the timeframe, the chance of color break up is reduced. By the same way, when the color cyan occupies the most of the portions of the image, the emitting time, the emitting sequence, or both can be adjusted to display the generated color sequence RGCMYBW. Also, when the color magenta occupies the most of the portions of the image, the emitting time, the emitting sequence, or both can be adjusted to display the generated color sequence RGCMYBW, and when the white color occupies the most of the portions of the image, the emitting time, the emitting sequence, or both can be adjusted to display the generated color sequence RGCMYBW. Besides, when one of the RGB color occupies the most of the portions of the image, then the generated color sequence remains unchanged. Therefore, by adjusting the emitting time, the emitting sequence, or both, the generated color sequence can be displayed to improve the color break up problem according to the color characteristic value of the frame signals 3.

While the display method is illustrated accompany with the description of the monitor, the following illustration with flow chart is provided for clarification.

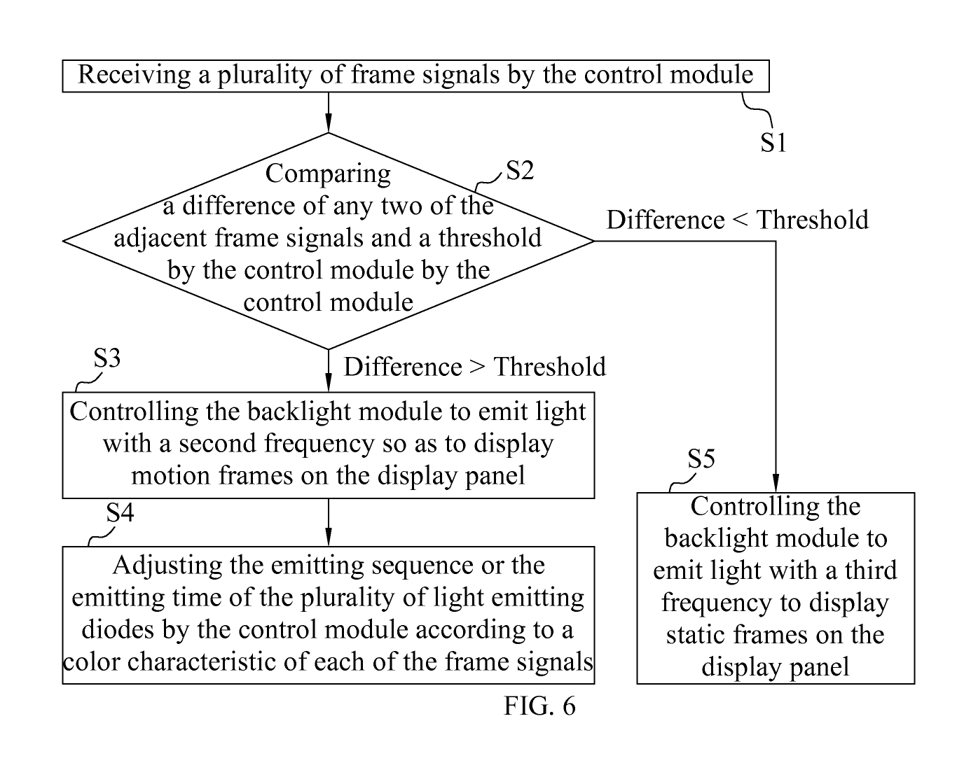

Please refer to FIG. 6, which is a flow chart illustrating the display method in accordance with the present invention. The monitor comprises a display panel, a backlight module, and a control module, and the backlight module comprises a plurality of light emitting diodes and emits light with the first period. As shown, the display method comprises the following steps: (S1) receiving a plurality of frame signals by the control module; (S2) comparing a difference of any two of the adjacent frame signals with a threshold by the control module; (S3) controlling the backlight module to emit light with the second period when the difference is larger than the threshold so as to display a motion frame on the display panel; and (S4) adjusting the emitting sequence or the emitting time of the plurality of light emitting diodes by the control module according to a color characteristic of each of the frame signals.

In the step (S2), when the difference is smaller than the threshold, performing the step (S5) of controlling the backlight module to emit light with a third period so as to display a static frame on the display panel.

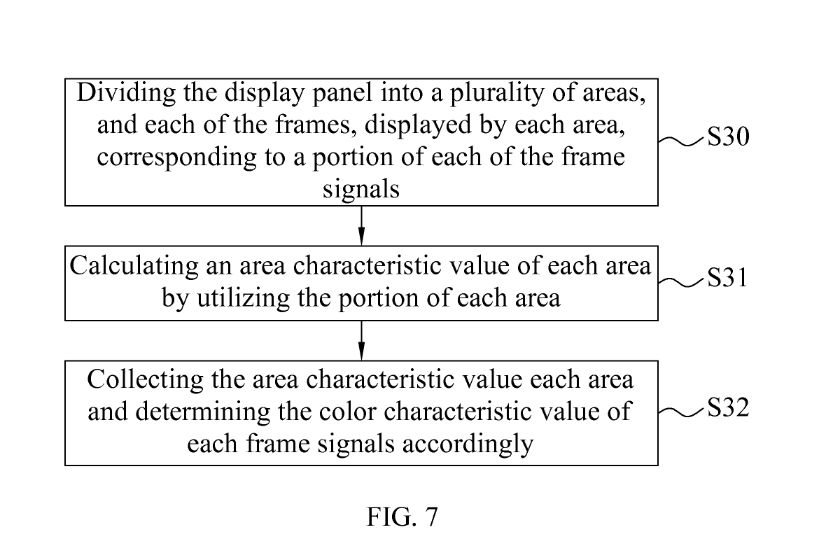

Beside, as shown in FIG. 7, before the step (S4), the display method further comprises the following steps by the control module: (S30) dividing the display panel into a plurality of areas, and each of the frames, displayed by each area, corresponding to a portion of each of the frame signals; (S31) calculating an area characteristic value of each area by utilizing the portion of each area; and (S32) collecting the area characteristic value of each area and determining the color characteristic value of each frame signals accordingly.

The aforementioned function and interaction between elements are illustrated with the description of the monitor.

To sum up, the monitor and the display method are disclosed in the present invention. The display method determines the backlight module to emit with different mode by comparing a difference of any two adjacent frame signals with a threshold value. Also, the color breakup problem and contouring problem can be effectively solved by adjusting the emitting sequence or the emitting time of the plurality of light emitting diodes.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiments of the present invention.

What is claimed is:

1. A display method of a monitor, the monitor comprising a display panel, a backlight module, and a control module, the backlight module comprising a plurality of light emitting diodes emitting light with a first period to display frames on the display panel, the display method comprising the following steps:
receiving frame signals by the control module;
comparing a difference of any two of the adjacent frame signals with a threshold by the control module; and
controlling the backlight module to emit light with a second period when the difference is larger than the threshold.

2. The display method as recited in claim 1, wherein the backlight module is controlled to emit light with a third period when the difference is smaller than the threshold.

3. The display method as recited in claim 2, further comprising the step of adjusting emitting sequences or emitting durations of the plurality of light emitting diodes by the control module according to a color characteristic value of each of the frame signals.

4. The display method as recited in claim 3, further comprising the following steps performed by the control module:
dividing the display panel into a plurality of areas, and each of the frames, displayed by each area, corresponding to a portion of each of the frame signals;
calculating an area characteristic value of each of the plurality of areas by utilizing the portion of each of the frame signals; and
collecting the area characteristic value of each of the plurality of areas and determining the color characteristic value of each of the frame signals accordingly.

5. The display method as recited in claim 4, wherein the control module utilizes the portion, corresponding to the frames of each area, of each of the frame signals to calculate a saturation and a hue of each of the plurality of areas respectively, and the color characteristic value thereof is determined according to the saturation and the hue.

6. A display method for a monitor, the monitor comprising a display panel, a backlight module, and a control module, the backlight module comprising a plurality of light emitting diodes, the display method comprising the following steps:
receiving frame signals by the control module;
emitting light with a first period by the backlight module to display frames on the display panel; and
adjusting emitting sequences or the emitting durations of the plurality of light emitting diodes according to a color characteristic value of each of the frame signals by the control module.

7. The display method as recited in claim 6, further comprising the following steps performed by the control module:
dividing the display panel into a plurality of areas, and each of the frames, displayed by each area, corresponding to a portion of each of the frame signals;
calculating an area characteristic value of each of the plurality of areas by utilizing the portion of each of the frame signals; and
collecting the area characteristic value of each of the plurality of areas and determining the color characteristic value of each of the frame signals accordingly.

8. The display method as recited in claim 7, wherein the control module utilizes the portion, corresponding to the frames of each area, of each of the frame signals to calculate a saturation and a hue of each of the plurality of areas respectively, and the color characteristic value of each of the plurality of areas is determined accordingly.

9. The display method as recited in claim 6, further comprising the following steps:
receiving the frame signals by the control module;
comparing a difference of any two of the adjacent frame signals with a threshold by the control module; and
controlling the backlight module to emit light with a second period when the difference is larger than the threshold so as to display motion frames on the display panel.

10. A monitor, comprising:
a display panel displaying frames;
a backlight module comprising a plurality of light emitting diodes and emitting light with a first period to display frames on the display panel; and
a control module electrically connected to the display panel and the backlight module;
wherein the control module receives the frame signals and compares a difference of any two of the adjacent frame signals with a threshold by the control module, and the backlight module is controlled to emit light with a second period when the difference is larger than the threshold.

11. The monitor as recited in claim 10, wherein the backlight module is controlled to emit light with a third period when the difference is smaller than the threshold.

12. The monitor as recited in claim 10, wherein the control module adjusts emitting sequences or the emitting durations of the plurality alight emitting diodes according to a color characteristic value of each of the frame signals.

13. The monitor as recited in claim 12, wherein the control module divides the display panel into a plurality of areas, and each of the frames, displayed by each of the plurality of areas, corresponds to a portion of each of the frame signals; the control module calculates an area characteristic value of each of the plurality of areas by utilizing the portion of each of the plurality of areas, and collects the area characteristic value of each of the plurality of areas, and determines the color characteristic value of each frame signals accordingly.

14. A monitor, comprising:
a display panel displaying frames;
a backlight module comprising a plurality of light emitting diodes and emitting with a first period to display the frames on the display panel; and
a control module electrically connected to the display panel and the backlight module;
wherein the control module receives frame signals and adjusts emitting sequences or emitting durations of the plurality of light emitting diodes according to a color characteristic value of each of the frame signals.

15. The monitor as recited in claim 14, wherein the control module divides the display panel into a plurality of areas, and each of the frames, displayed by each of the plurality of area, corresponds to a portion of each of the frame signals; the control module calculates an area characteristic value of each of the plurality of areas by utilizing the portion of each of the frame signals, and collects the area characteristic value of each of the plurality of areas, and determines the color characteristic value of each of the frame signals accordingly.

16. The monitor as recited in claim 15, wherein the control module utilizes the portion of each of the frame signals, corresponding to the frame of each of the plurality of areas, to calculate a saturation and a hue of each of the plurality of areas respectively, and the color characteristic value of each of the plurality of areas is determined according to the saturation and the hue.

17. The monitor as recited in claim 16, wherein the control module receives the frame signals and compares a difference of any two of the adjacent frame signals with a threshold, and the backlight module is controlled to emit light with a second period when the difference is larger than the threshold.
